(19) United States
(12) Patent Application Publication
(10) Pub. No.: US 2024/0290058 A1
(43) Pub. Date: Aug. 29, 2024

(54) INFORMATION PROCESSING APPARATUS AND PROGRAM

(71) Applicant: Sony Interactive Entertainment Inc., Tokyo (JP)

(72) Inventor: Atsushi KIMURA, Tokyo (JP)

(73) Assignee: Sony Interactive Entertainment Inc., Tokyo (JP)

(21) Appl. No.: 18/560,684

(22) PCT Filed: May 21, 2021
(86) PCT No.: PCT/JP2021/019420

§ 371 Date: Nov. 14, 2023

(51) Int. Cl. G06V 10/22; G06T 7/55

(52) U.S. Cl. CPC G06V 10/235; G06T 7/55

(57) ABSTRACT

Disclosed is an information processing apparatus that calculates a distance between images taken by a camera at multiple camera stations in a three-dimensional space. The information processing apparatus includes region setting means for setting, as a target region for each camera station, a range of a predetermined shape in a projection plane at a distance determined by a predetermined method relative to the camera within a frustum of the camera at each camera station, on the basis of information regarding a posture of the camera at each camera station, and calculation means for calculating, as a distance value, a proportion in which, given a pair of the images targeted for the distance calculation, the target region for the camera station from which one of the images is taken is included in the target region for the camera station from which the other image is taken.

### TECHNICAL FIELD

The present invention relates to an information processing apparatus and a program for evaluating a distance between images.

### BACKGROUND ART

The techniques for simultaneously estimating both an own position and an environmental map by use of various sensors (SLAM: Simultaneous Localization and Mapping) are well known. Of the SLAM techniques, those that use only cameras as the sensors are called visual SLAM.

The SLAM techniques are known to be associated with diverse realization procedures. One such procedure involves selecting, as a key frame, some of the images taken by a camera and comparing the last-taken image with the key frame in terms of feature points of a subject in the images to estimate the position of the camera and the direction of the imaging thereby.

### SUMMARY

### Technical Problem

To compare the feature points by means of the SLAM techniques requires that the key frame and the last-taken image both include a common subject. In order to select the key frame for the feature point comparison, it is general practice to select an image which serves as the key frame candidate and of which a camera station is close to a camera station of the last-taken image.

In such examples, the distance between the taken images has so far been obtained as the Euclidean distance between the camera stations. However, the images taken from each camera station differ from each other not only in terms of camera positions (camera stations) but also in terms of the viewing angles (imaging angles) of the camera. Even if the camera stations are close to each other, a common subject may or may not be imaged from these camera stations.

The above problem can be experienced not only in SLAM but also in various processes that use multiple images taken by a camera moving in a three-dimensional space.

The present invention has been made in view of the above circumstances. An object of the invention is therefore to provide an information processing apparatus, an information processing method, and a program for calculating the distance better suited for comparison between multiple images taken by a camera moving in a three-dimensional space.

### Solution to Problem

In solving the above problem and according to one embodiment of the present invention, there is provided an information processing apparatus for calculating a distance between images taken by a camera multiple camera stations in a three-dimensional space. The information processing apparatus includes region setting means for setting, as a target region for each camera station, a range of a predetermined shape in a projection plane at a distance determined by a predetermined method relative to the camera within a frustum of the camera at each camera station, on the basis of information regarding a posture of the camera at each camera station, and calculation means for calculating, as a distance value, a proportion in which, given a pair of the images targeted for the distance calculation, the target region for the camera station from which one of the images is taken is included in the target region for the camera station from which the other image is taken. The calculated distance value is submitted to a predetermined process.

### Advantageous Effect of Invention

According to the present invention, a distance between multiple images taken by a camera moving in a three-dimensional space is calculated by comparison between the imaging ranges of the images. This makes it possible to calculate the distance better suited for comparison between the images involved.

### BRIEF DESCRIPTION OF DRAWINGS

FIG. 1 is a block diagram depicting an exemplary configuration of an information processing apparatus according to an embodiment of the present invention.

FIG. 2 is a functional block diagram depicting an example of the information processing apparatus according to the embodiment of the present invention.

FIG. 3 is an explanatory diagram depicting a target region set by the information processing apparatus according to the embodiment of the present invention.

FIG. 4 is a flowchart indicating an exemplary process of distance calculation performed by the information processing apparatus according to the embodiment of the present invention.

FIG. 5 is a flowchart indicating an exemplary process of key frame management performed by the information processing apparatus according to the embodiment of the present invention.

FIG. 6 is a flowchart indicating an exemplary process of key frame selection performed by the information processing apparatus according to the embodiment of the present invention.

### DESCRIPTION OF EMBODIMENT

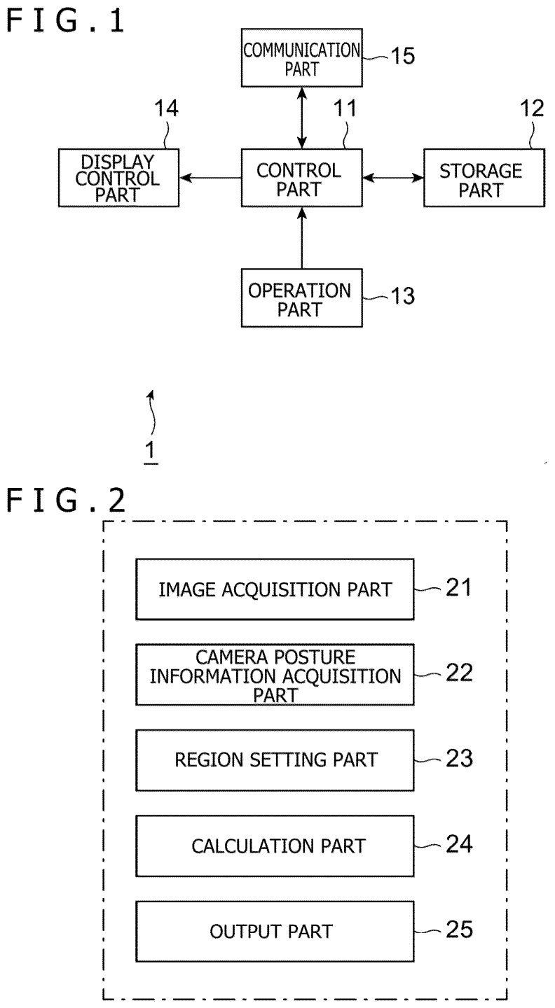

An embodiment of the present invention is described below with reference to the accompanying drawings. An information processing apparatus 1 according to the embodiment of the present invention is implemented as a computer device such as a household game console or a personal computer, for example. As depicted in FIG. 1, the information processing apparatus 1 includes a control part 11, a storage part 12, an operation part 13, a display control part 14, and a communication part 15.

Here, the control part 11 is a program-controlled device such as a central processing unit (CPU) that operates in accordance with programs stored in the storage part 12. In order to calculate a distance between images taken by a camera from multiple camera stations in a three-dimensional space, the control part 11 of the present embodiment sets, as a target region for each camera station, a range of a predetermined shape in a projection plane at a distance determined by a predetermined method relative to a camera within the frustum of the camera at each camera station, on the basis of information regarding a posture of the camera at each camera station.

Given a pair of images targeted for the distance calculation, the control part 11 calculates, as a distance value, a proportion in which the target region for the camera station from which one image is taken is included in the target region for the camera station from which the other image is taken. Then, the control part 11 submits the distance value thus calculated to relevant processes such as those of SLAM. The detailed processing of the control part 11 will be discussed later.

The storage part 12 is a memory device or a disk device, for example, and holds the programs to be executed by the control part 11. The storage part 12 also stores various kinds of data necessary for the processing of the control part 11, such as the image data to be processed. The storage part 12 thus functions as a work memory for the control part 11 as well.

The operation part 13 receives input of instructions from a user of the information processing apparatus 1. If the information processing apparatus 1 is a household game console, for example, the operation part 13 receives signals indicative of the details the user's operations from a controller (not depicted) of the information processing apparatus 1, and outputs information indicating the details of the operations to the control part 11. The display control part 14 is connected to a display unit, for example, and, in accordance with instructions input from the control part 11, outputs image data as instructed for display on the display unit, for example.

The communication part 15 includes a serial interface such as a universal serial bus (USB) interface and a network interface, for example. The communication part 15 receives image data from an external device such as a camera connected via the serial interface, for example, and outputs the received image data to the control part 11. Further, the communication part 15 may operate to output the data received via the network to the control part 11, or may operate to output data via the network in accordance with instructions input from the control part 11.

Explained next is the process of distance calculation performed by the control part 11. It is to be noted that, in the ensuing description of examples of the present embodiment, the term “distance” may or may not match the concept of distance in mathematical sense.

In calculating the distance between images, the control part 11 executes programs stored in the storage part 12. By so doing, the control part 11 implements functionally an image acquisition part 21, a camera posture information acquisition part 22, a region setting part 23, a calculation part 24, and an output part 25 configured as depicted in FIG. 2.

Here, the image acquisition part 21 acquires an image Ii (i=1, 2, . . . ) as a key frame by reading it from among the images taken so far by a camera from multiple camera stations in the three-dimensional space and stored in the storage part 12.

The camera posture information acquisition part 22 acquires posture information Pi (i=1, 2, . . . ) regarding the camera at each camera station Ti (i=1, 2, . . . ) from which the image Ii acquired by the image acquisition part 21 is taken. The camera posture information may be information estimated by SLAM or information that records the actual camera posture at the time of imaging. The camera posture information here may include position information ti (translation component) and a rotation matrix Ri (rotation component) of the camera at the camera station from which the i-th key frame has been imaged in a global coordinate system (e.g., an XYZ orthogonal coordinate system) set up in the three-dimensional space in which the camera moved. The camera posture information may further include a projection matrix ni of the camera for this key frame as defined on the basis of the position information ti (translation component) and the rotation matrix Ri (rotation component).

Here, the projection matrix n is a matrix that maps the points in the global coordinate system to the positions of the corresponding pixels of images (two-dimensional). The methods for calculating the projection matrix on the basis of the position information t (translation component) and rotation matrix R (rotation component) of the camera station are well known and thus will not be discussed further.

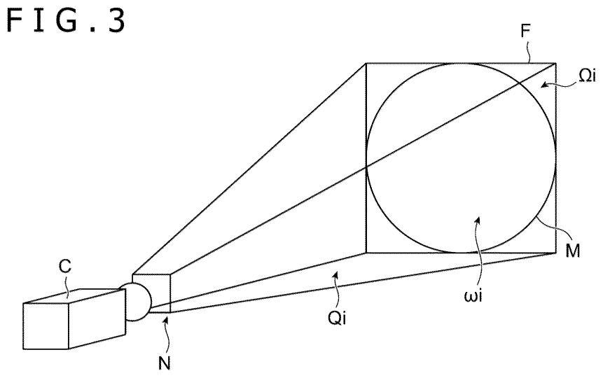

In the present embodiment, the imaging range of the camera is constituted, as depicted in FIG. 3, of a subject in a frustum Qi having an apex and a base, the apex being given by a coordinate Ti expressed by the position information t regarding the camera station in the camera posture information, the base being a plane (projection plane) of which the normal vector is the line-of-sight direction expressed by the rotation component (the frustum Qi is a frustum enclosed by a near plane N and a far plane F, the near plane N being a projection plane relatively close to a camera C, the far plane F being a projection plane relatively far from the camera C). In the case of an actual space, the far plane F is set substantially at an infinite distance. Also with the present embodiment, a predetermined projection plane Qi is defined by a projection plane at a distance determined separately by a predetermined method relative to the camera C.

The region setting part 23 sets, as the target region for each camera station, a range ωi of a predetermined shape M in the predetermined projection plane Ωi at a distance L determined by a predetermined method relative to the camera within the frustum Qi of the camera at each camera station, on the basis of the projection matrix πi as the information regarding the camera posture at each camera station from which the image Ii acquired by the image acquisition part 21 is taken. Here, the predetermined shape M may be an entire rectangle of the projection plane Ωi, or an ellipse or some other shape internally tangent to or enclosed in this rectangle. It is also preferable that the shape be a curve (e.g., the shape may be an ellipse) of which the contour is differentiable.

For example, the region setting part 23 sets, as the target region, the range ωi of the predetermined shape M in the predetermined projection plane Ωi at a predetermined distance L0 from the camera within the frustum.

Given a pair of images targeted for the distance calculation, the calculation part 24 calculates, as the distance value, the proportion in which the target region for the camera station from which one image is taken is included in the target region for the camera station from which the other image is taken.

Specifically, the calculation part 24 performs either a first process or a second process, the first process calculating, according to a designated pair of images targeted for the distance calculation, the distance between the designated pair of images, the second process calculating, according to an input image targeted for the distance calculation, the distance between the input image and the image Ii (i=1, 2, . . . ) selected as the key frame.

First, in a case where the first process is performed, the calculation part 24 acquires pieces of camera position information ta and tb (translation components), rotation matrices Ra and Rb (rotation components), and projection matrices na and nb at the camera stations for the designated pair of images Ia and Ib, respectively. This operation is similar to that carried out by the camera posture information acquisition part 22 and thus will not be discussed further.

The calculation part 24 sets, as the target regions for the camera stations, ranges ωa and ωb of the predetermined shape M in the predetermined projection planes Ωa and Ωb at the distances L determined by a predetermined method relative to the camera at the camera stations from which the designated pair of images Ia and Ib are taken, respectively.

Next, given one of the designated pair of images such as the image Ia, the calculation part 24 multiplies the corresponding target region wa (expressed in the coordinate system of the camera C) by an inverse matrix πa of the projection matrix of the camera at the corresponding camera station, thereby transforming the information indicative of the target region into information in the global coordinate system. The calculation part 24 then obtains a transformation matrix Tab that transforms the camera posture (ta, Ra) at the camera station from which the one image Ia is taken, into a camera posture (tb, Rb) at the camera station from which the other image Ib is taken. The methods for calculating the transformation matrix are also well known and thus will not be discussed further.

The calculation part 24 obtains a range ω′a of the target region ωa set for the image Ia in coordinates of the camera at the camera station from which the other image Ib is taken, by using the following mathematical formula.

$$\begin{matrix}[ Math . 1 ] & \\ {ω}_{a}^{′} = {π}_{b} ( {T}_{a b} \cdot {π}_{a}^{- 1} ( {ω}_{a} ) ) & ( 1 )\end{matrix}$$

The calculation part 24 then obtains a distance d between the images Ia and Ib by using the following mathematical formula.

$$\begin{matrix}[ Math . 2 ] & \\ d = 1 - \frac{S ( {ω}_{b} ⋂ {ω}_{a}^{′} )}{max \{ S ( {ω}_{b} ) , S ( {ω}_{a}^{′} ) \}} & ( 2 )\end{matrix}$$

In the above mathematical formula, S (w) denotes the area of the range ω, and max {X, Y} represents whichever is the greater of the values X and Y. That is, the distance d is given by obtaining the proportion in which the target region wa set for the image Ia overlaps with the target region wb set for the image Ib in the imaging region of the camera having taken the image Ib, the proportion being divided by whichever is the greater of the areas of the respective target regions (one of them is converted to coordinates of the other imaging region of the camera) to provide a percentage to be subtracted from 1.

The distance d is 1 in a case where the target region for the one image Ia never overlaps with the other image Ib, while the distance d is 0 in a case where the target region for the one image Ia totally coincides with the target region for the other image Ib. Further, regardless of the target (subject) included in each of the images Ia and Ib, if the camera posture (i.e., the viewing angle) is the same at each camera station, the distance d becomes the same. Using the distance d, the present embodiment makes it possible to perform distance-based processes regardless of scenes.

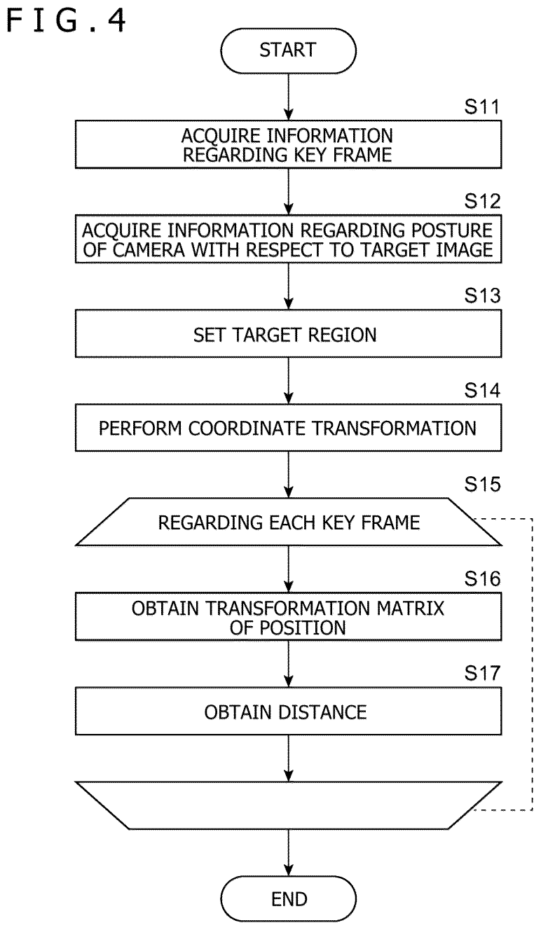

On the other hand, in a case where the second process is carried out, the calculation part 24 performs the processing steps indicated in FIG. 4, by receiving input of an image Ix targeted for the distance calculation. The calculation part 24 acquires the camera posture information Pi for the key frame image Ii (i=1, 2, . . . ) acquired by the camera posture information acquisition part 22 and the target region wi set by the region setting part 23 for each camera station for the key frame image (S11).

The calculation part 24 then acquires the camera posture information Px (assumed to include camera posture position information tx (translation component), a rotation matrix Rx (rotation component), and a projection matrix πx) at the camera station from which the image Ix targeted for the distance calculation is taken (S12). This processing step is similar to that carried out by the camera posture information acquisition part 22.

The calculation part 24 then sets the target region ox corresponding to the image Ix targeted for the distance calculation (S13). This processing step is similar to that carried out by the region setting part 23 and thus will not be discussed further. The calculation part 24 multiplies the target region ox (expressed in the camera coordinate system) corresponding to the image Ix by the inverse matrix nx of the projection matrix of the camera at the corresponding camera station, thereby transforming the information indicative of the target region into information in the global coordinate system (S14).

The calculation part 24 then performs the following processing steps repeatedly by successively selecting the image Ii of each key frame (S15). That is, the calculation part 24 first obtains a transformation matrix Txi that transforms the camera posture (tx, Rx) at the camera station from which the image Ix is taken into a camera posture (ti, Ri) at the camera station from which the selected key frame image Ii is taken (S16).

The calculation part 24 then obtains a range ω′x of the target region ox set for the image Ix in camera coordinates at the camera station from which the selected key frame image Ii is taken, in a manner similar to mathematical formula (1) above as follows.

$${ω}_{x}^{′} = {π}_{i} ( {T}_{xi} \cdot {π}_{x}^{- 1} ( {ω}_{x} ) ) \qquad [ Math . 3 ]$$

The calculation part 24 further obtains a distance d (x, i) between the image Ix and the selected key frame image Ii in a manner similar to mathematical formula (2) above as follows (S17).

$$d ( x , i ) = 1 - \frac{S ( {ω}_{i} ⋂ {ω}_{x}^{′} )}{max \{ S ( {ω}_{i} ) , S ( {ω}_{x}^{′} ) \}} \qquad [ Math . 4 ]$$

The calculation part 24 repeatedly performs the processing steps S16 and S17 above on the designated image Ix and on the image Ii (i=1, 2, . . . ) selected as the key frame, thereby obtaining the distance d (x, i) between the designated image Ix and the image Ii of each key frame. The output part 25 outputs the value of the distance obtained by the calculation part 24.

### [Operations]

The information processing apparatus 1 of the present embodiment is basically configured as explained above, and operates as described below. It is to be noted that, whereas the information processing apparatus 1 is described below as performing the distance calculation using SLAM for explanation purposes, the processes carried out by the information processing apparatus 1 of the present embodiment by using the calculated distance information are not limited to the SLAM processing.

In addition, the SLAM processing used hereunder is based on “G. Klein, D. W. Murray, Parallel Tracking and Mapping for Small AR Workspaces, ISMAR, pp. 1-10, 2007 (DOI 10.1109/ISMAR.2007.4538852).” The processing involves setting an image or images serving as a key frame or frames (there may be multiple key frames) from among the images taken at multiple camera stations by a camera moving in the three-dimensional space, selecting any one of the key frames, and comparing the selected key frame with the last-taken image to estimate the position and posture of the camera having taken the image most recently.

The information processing apparatus 1 performs the processes of
key frame generation,
key frame deletion, and
closest proximity searches
   on the key frames.

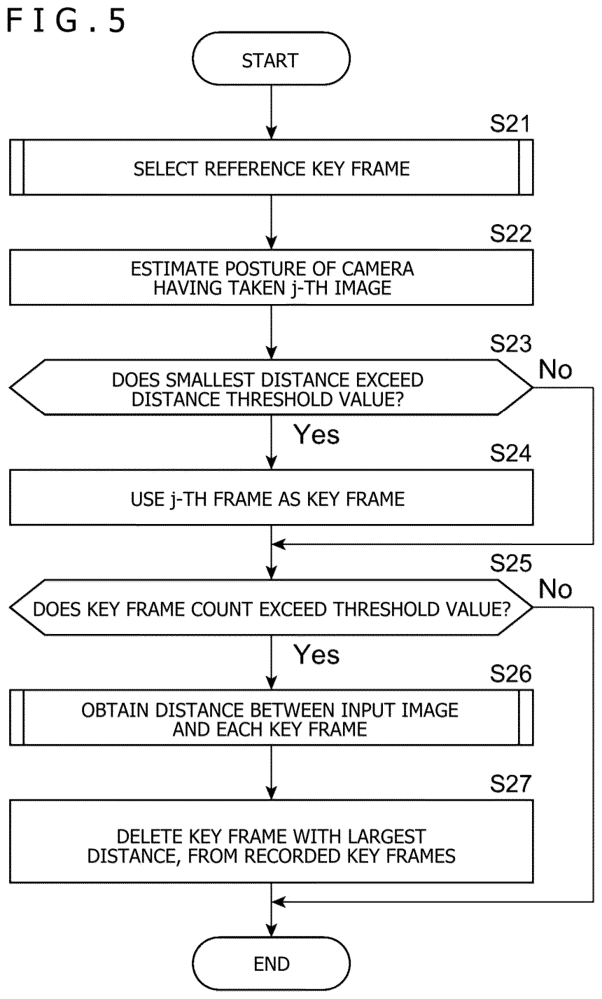

When a newly-taken image Ix is input, the information processing apparatus 1 records the image Ix as the key frame as it is if the image Ix is the initially input first frame. Further, when an image Ix of a second or subsequent frame is input, the information processing apparatus 1 performs the processing step of selecting a reference key frame as indicated in FIG. 5 (S21), and selects the key frame for estimating the posture of the camera having taken the input image Ix.

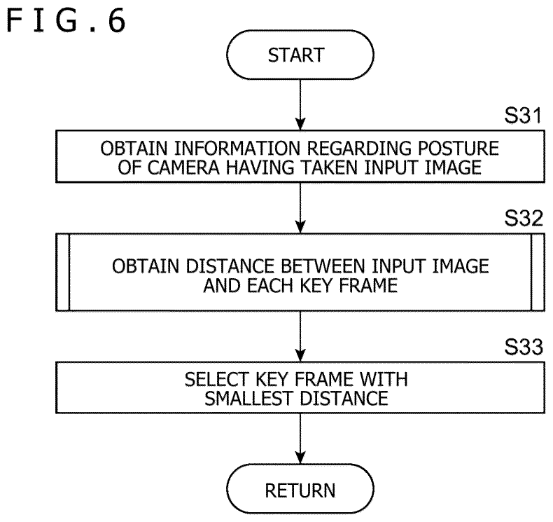

In this processing step, as indicated in FIG. 6, the information processing apparatus 1 predicts the posture of the camera having taken the image Ix of the j-th frame, from the input image Ix of the j-th frame and from the images of one or a predetermined number of the most-recently input frames, i.e., the (j−1)th frame, the (j−2)th frame, . . . , to obtain posture information (S31) regarding the camera at the camera station from which the image Ix of the j-th frame is taken (the posture is predicted from the estimates of past frames as the posture of an entity moving at angular velocity such as in uniform motion or moving at constant or equiangular acceleration; this posture is referred to as the provisional posture hereunder). The posture estimation here may be performed by well-known SLAM methods and thus will not be discussed further. Then, the information regarding the provisional camera posture is used to obtain the distance between each key frame and the input image Ix (S32: the process indicated in FIG. 4).

Given the obtained distances d(x, i), the information processing apparatus 1 selects the key frame Ii with the smallest distance value (S33).

Returning to the process in FIG. 5, the information processing apparatus 1 estimates the posture of the camera having taken the image Ix of the j-th frame, by use of the image Ix of the input j-th frame and the image Ii of the key frame selected in step S21 (S22).

The information processing apparatus 1 then determines whether or not the smallest distance obtained in step S33 of FIG. 6 exceeds a predetermined distance threshold value (S23). In a case where the smallest distance is determined to exceed the distance threshold value (S23: Yes), the information processing apparatus 1 records the image Ix of the input j-th frame as the key frame (S24).

Further, the information processing apparatus 1 counts the number of the images recorded as the key frames, to determine whether or not the image count exceeds a predetermined key frame count threshold value (S25). In a case where the number of the images recorded as the key frames is determined to exceed a predetermined key frame count threshold value (S25: Yes), the information processing apparatus 1 obtains the distance between each key frame and the input image Ix by using the estimated posture of the camera having taken the image Ix of the j-th frame obtained in step S22 (S26: the process indicated in FIG. 4).

Then, given the distances d(x, i) obtained here, the information processing apparatus 1 selects the key frame Ii with the largest distance value and deletes the selected key frame Ii from the recorded key frames (S27). It is to be noted that the image data itself may be left intact (i.e., the image itself may be preserved while the information such as the feature points as the key frame is deleted) without being deleted. It is to be noted that, if, in step S23, the smallest distance obtained in step S33 of FIG. 6 does not exceed the predetermined distance threshold value (S23: No), the information processing apparatus 1 goes to step S25 and continues the process. Further, if, in step S25, the number of the images recorded as the key frames does not exceed the key frame count threshold value (S25: No), the information processing apparatus 1 terminates the process without carrying out steps S26 and S27.

Every time a new frame image is input, the information processing apparatus 1 repeatedly performs the process indicated in FIG. 5 until the imaging is terminated. By so doing, the information processing apparatus 1 acquires the position of the camera station from which each frame is taken and the information regarding the camera posture in that position.

### [Error Calculation]

Further, the distance calculated by the information processing apparatus 1 of the present embodiment is independent of scenes. For example, in a situation where the scene may change and where the camera takes images while moving from its initial position and eventually returning thereto, the posture of the camera is estimated on the basis of the image taken in the initial position and the image taken by the camera having returned thereto. The information regarding the estimated camera posture may then be used to calculate the distance between the image taken in the initial position and the image taken by the camera upon return thereto, by using the process indicated in FIG. 4.

In the case above, the value of the calculated distance may be utilized as representative of the difference between the initial position and posture of the camera and the position and posture of the camera having returned to the initial position, i.e., as an error in the movement of the camera.

### [Distance to the Projection Plane]

In addition, although it has been explained above that, when the target region is to be set for each camera station, the information processing apparatus 1 sets, as the target region for each camera station, the range ωi of the predetermined shape M in the predetermined projection plane Qi at the distance L determined by a predetermined method relative to the camera within the frustum Qi of the camera at each camera station, this is not limitative of how the present embodiment may operate.

For example, in a case where the distance (depth) between the camera and the target (subject) included in the image taken from each camera station is obtained by SLAM methods, the information processing apparatus 1 may use statistics of the depth (e.g., an arithmetic average or a mode value from division into predetermined bins) to set, as the target region for each camera station, the range ωi of the predetermined shape M in the predetermined projection plane Qi at the distance L corresponding to the statistics relative to the camera within the frustum Qi of the camera at each camera station.

### REFERENCE SIGNS LIST

1: Information processing apparatus
11: Control part
12: Storage part
13: Operation part
14: Display control part
15: Communication part
21: Image acquisition part
22: Camera posture information acquisition part
23: Region setting part
24: Calculation part
25: Output part

1. An information processing apparatus for calculating a distance between images taken by a camera at multiple camera stations in a three-dimensional space, the information processing apparatus comprising:
region setting means for setting, as a target region for each camera station, a range of a predetermined shape in a projection plane at a distance determined by a predetermined method relative to the camera within a frustum of the camera at each camera station, on a basis of information regarding a posture of the camera at each camera station; and
calculation means for calculating, as a distance value, a proportion in which, given a pair of the images targeted for the distance calculation, the target region for the camera station from which one of the images is taken is included in the target region for the camera station from which the other image is taken,
wherein the calculated distance value is submitted to a predetermined process.

2. The information processing apparatus according to claim 1, wherein the region setting means sets, as the target region for each camera station, the range of the predetermined shape in the projection plane at a predetermined distance relative to the camera within the frustum of the camera at each camera station.

3. The information processing apparatus according to claim 1, wherein the region setting means obtains predetermined statistics of a distance from the camera at each camera station to a subject imaged by the camera at the camera station in question, the region setting means further setting, as the target region for each camera station, the range of the predetermined shape in the projection plane at a distance given by the obtained predetermined statistics relative to the camera within the frustum of the camera at each camera station.

4. The information processing apparatus according to claim 1, wherein the predetermined shape is either a rectangle or an ellipse.

5. The information processing apparatus according to claim 1, wherein the predetermined shape is either a rectangle or an ellipse internally tangent to the projection plane.

6. The information processing apparatus according to claim 1, wherein the predetermined process relates to a key frame in simultaneous localization and mapping.

7. An information processing method for calculating a distance between images taken by a camera at multiple camera stations in a three-dimensional space, the information processing method comprising:
by region setting means, setting, as a target region for each camera station, a range of a predetermined shape in a projection plane at a distance determined by a predetermined method relative to the camera within a frustum of the camera at each camera station, on a basis of information regarding a posture of the camera at each camera station; and
by calculation means, calculating, as a distance value, a proportion in which, given a pair of the images targeted for the distance calculation, the target region for the camera station from which one of the images is taken is included in the target region for the camera station from which the other image is taken,
wherein the calculated distance value is submitted to a predetermined process.

8. A program for calculating a distance between images taken by a camera at multiple camera stations in a three-dimensional space, the program being for a computer, comprising:
by region setting means, setting, as a target region for each camera station, a range of a predetermined shape in a projection plane at a distance determined by a predetermined method relative to the camera within a frustum of the camera at each camera station, on a basis of information regarding a posture of the camera at each camera station; and
by calculation means, calculating, as a distance value, a proportion in which, given a pair of the images targeted for the distance calculation, the target region for the camera station from which one of the images is taken is included in the target region for the camera station from which the other image is taken,
wherein the calculated distance value is submitted to a predetermined process.
